(19) United States
(12) Patent Application Publication
(10) Pub. No.: US 2026/0331541 A1
(43) Pub. Date: Oct. 22, 2026

(54) METHOD AND DEVICE FOR CONDITIONING A FUEL CELL STACK

(71) Applicant: Robert Bosch GmbH, Stuttgart (DE)

(72) Inventors: Anton Ringel, Bamberg (DE); Michael Giuseppe Marino, Linz (AT)

(21) Appl. No.: 19/479,919

(22) PCT Filed: Apr. 9, 2024
(86) PCT No.: PCT/EP2024/059551

§ 371 Date: Oct. 29, 2025

(30) Foreign Application Priority Data
May 10, 2023 (DE) 10 2023 204 302.5

(51) Int. Cl. H01M 8/04225; H01M 8/04119

(52) U.S. Cl. CPC H01M 8/04225; H01M 8/04126

(57) ABSTRACT

The invention presented relates to a conditioning method (100) for conditioning a fuel cell stack (229), wherein the conditioning method (100) comprises:—permeating (101) the fuel cell stack (229) with an operating medium, wherein the operating medium is guided in a first direction through the fuel cell stack (229) and—permeating (103) the fuel cell stack (229) with the operating medium in a second direction opposite to the first direction,—operating the fuel cell stack (229) at a constant operating point.

### BACKGROUND

The invention relates to a method and device for conditioning a fuel cell stack.

A newly constructed polymer electrolyte membrane fuel cell stack requires a conditioning process to achieve its full efficiency.

During the conditioning process, the membrane and the ionomer components of the fuel cell stack are hydrated in the catalyst region. Furthermore, the catalyst or catalyst layers are activated, for example by reducing surface oxides on Pt catalyst particles. To this end, impurities such as organic residues and particles are rinsed out during the conditioning process.

Various conditioning processes are already known.

### SUMMARY

The invention presents a conditioning method and a device for conditioning a fuel cell stack. Further features and details of the invention arise from the description and the drawings. The features and details described in connection with the conditioning method according to the invention naturally also apply in connection with the device according to the invention and vice versa, so that mutual reference can always be made to the disclosure of the individual aspects of the invention.

The invention presented is particularly useful for conditioning a fuel cell stack.

Accordingly, a conditioning method for conditioning a fuel cell stack is presented in accordance with a first aspect of the invention.

The conditioning method described comprises permeating the fuel cell stack with an operating medium, wherein the operating medium is guided through the fuel cell stack in a first direction.

Furthermore, the conditioning method presented comprises permeating the fuel cell stack with the operating medium in a second direction opposite to the first direction and operating the fuel cell stack at a constant operating point.

The conditioning method presented is based on operating a respective fuel cell stack or a corresponding fuel cell system to be conditioned at a constant operating point. This means that control parameters and process parameters remain essentially unchanged during operation of the fuel cell stack during the conditioning method.

This constant operating point leads to particularly high water production at a low potential at the periphery of the fuel cell stack, so that impurities accumulated there are flushed out and the fuel cell stack is effectively conditioned.

Since water production decreases in the direction of flow at a constant operating point, the invention provides that the fuel cell stack is permeated with the operating medium in a second direction opposite to the first direction. This means that the fuel cell stack is permeated with the operating medium in two different directions or that a change in the direction of flow is carried out. The change in the direction of flow causes one side of the fuel cell stack to be conditioned first, followed by the other side.

It may be specified that the operating point provides maximum electrical efficiency from the fuel cell stack.

By setting the operating point at which maximum electrical efficiency or maximum electrical current is provided, maximum water production is achieved, so that a particularly large amount of water is provided, which efficiently flushes out the respective contaminants and conditions the fuel cell stack thoroughly and efficiently.

It may also be provided that, for permeating the fuel cell stack with the operating medium in the first direction, the operating medium is guided into a first region of the fuel cell stack, and for permeating the fuel cell stack with the operating medium in the second direction, the operating medium is guided into a second region of the fuel cell stack, wherein the first region is opposite the second region.

To change the direction of flow, the operating medium can, for example, first be guided into the fuel cell stack at an inlet region, i.e., a region that acts as an inlet during control operation or normal operation, and then at an outlet region, i.e., a region that acts as an outlet during control operation or normal operation.

Opposite regions for guiding the operating medium ensure that the fuel cell stack is permeated from two opposite directions or in two different directions or in opposite directions of flow.

It may also be provided that the fuel cell stack is first permeated with the operating medium in the first direction and then in the second direction in a gas exchange step, and that the gas exchange step is repeated.

By repeating the gas exchange step, the fuel cell stack is repeatedly permeated with the operating medium in different directions of flow, so that different regions of the fuel cell stack are rinsed with water several times and conditioned effectively.

It may also be provided that the gas exchange step is repeated until an increase in efficiency of selected fuel cells of the fuel cell stack during supply with the operating medium falls below a predefined efficiency threshold value.

The gas exchange step can be carried out in particular until a required minimum efficiency of the fuel cell stack is reached. This is usually the case when the increase in efficiency of selected fuel cells in the fuel cell stack falls below a predefined efficiency threshold value during supply with the operating medium, so that a further increase in efficiency through continued permeating with the operating medium is only minimal.

It may also be provided that, after the gas exchange step, a post-conditioning step is carried out in which the operating medium is guided into the fuel cell stack with a second lambda value that is greater than the first lambda value with which the operating medium is guided into the fuel cell stack during the gas exchange step, wherein, during the post-conditioning step, an operating point of the fuel cell stack is periodically changed.

A combination of a gas exchange step, which is performed at a constant operating point, and a post-conditioning step performed at a variable or safely changing operating point causes significant water production at a low potential during the gas exchange step in respective peripheral regions and during the post-conditioning step in an intermediate region between the peripheral regions, so that the entire fuel cell stack is effectively conditioned.

It may also be provided that the first lambda value is between 0.9 and 1.1, in particular at 1.0, and that the second lambda value is between 1.1 and 1.9, in particular at 1.2 or 1.4 or 1.6 or 1.8.

During the gas exchange step in particular, a lambda value of approx. 1.0 has proven to be particularly suitable for providing water and conditioning the peripheral regions of a fuel cell stack.

During the post-conditioning step in particular, a lambda value between 1.1 and 1.9, especially 1.2 or 1.4 or 1.6 or 1.8, has proven to be particularly suitable for providing water or for conditioning in an intermediate region between the respective peripheries of a fuel cell stack.

It may also be provided that, while the fuel cell stack is being permeated with the operating medium, an anode subsystem of the fuel cell stack is permeated with fuel in a stoichiometric excess.

Particularly high water production is achieved by supplying the anode subsystem with excess fuel, e.g. with a lambda value of 1.2.

It may be provided that the fuel, in particular hydrogen, is guided through the anode subsystem in different or alternating directions of flow, analogous to the supply of air.

According to a second aspect, the invention relates to a device for conditioning a fuel cell stack.

The device presented comprises a first supply system for supplying fuel to an anode subsystem of the fuel cell stack, a second supply system for supplying air to a cathode subsystem of the fuel cell stack, and a computing unit configured to carry out a possible configuration of the conditioning method presented, wherein at least the second supply system comprises a plurality of valves by means of which a direction of movement with which the air flows through the cathode subsystem can be reversed.

The respective valves of the plurality of valves of the presented device can act as inlet or outlet valves, depending on the desired direction of flow. For example, the valves can be connected via a pipe system that allows fuel to directly permeate the fuel cell stack and also allows fuel to flow into a valve in a first direction, to permeate the fuel cell stack in a second direction opposite to the first direction, and to flow out in the first direction. For example, four valves can be provided to form three flow paths, namely a first flow path directly through the fuel cell stack, a second flow path opposite to the first flow path through the fuel cell stack, and an outlet path past the fuel cell stack.

It may also be provided that the first supply system comprises a plurality of valves by means of which a direction of movement with which fuel flows through the anode subsystem can be reversed.

By means of an arrangement of valves in the first supply system, which is, for example, a hydrogen supply system, by means of which a direction of movement with which fuel flows through the anode subsystem can be reversed, a movement of fuel through an anode subsystem of the fuel cell stack can be achieved analogously to a movement of air through a cathode subsystem of the fuel cell stack.

### BRIEF DESCRIPTION OF THE DRAWINGS

Advantages that have been described in detail with regard to the conditioning method for conditioning a fuel cell stack according to the first aspect of the invention apply equally to the device for conditioning a fuel cell stack according to the second aspect of the invention and vice versa. Further advantages features and details of the invention are apparent from the following description, in which exemplary embodiments of the invention are described in detail with reference to the drawings. In this context, the features mentioned in the claims and in the description can each be essential to the invention individually or in any combination.

Shown are:

FIG. 1 a possible configuration of the conditioning method described above.

FIG. 2 a schematic representation of a possible configuration of the presented device in a first state.

FIG. 3 the device according to FIG. 2 in a second state.

### DETAILED DESCRIPTION

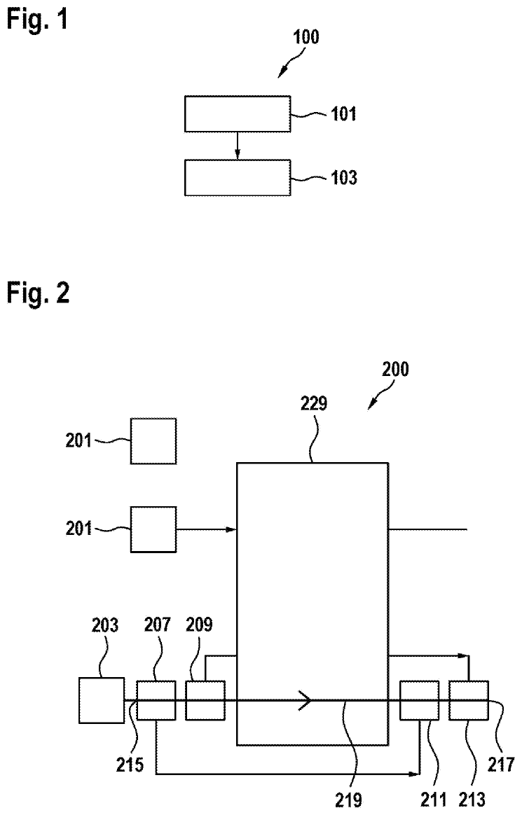

FIG. 1 shows a conditioning method 100 for conditioning a fuel cell stack.

The conditioning method 100 comprises a first permeating step 101, in which the fuel cell stack is permeated with an operating medium, wherein the operating medium is guided through the fuel cell stack in a first direction.

Furthermore, the conditioning method 100 comprises a second permeating step 103 in which the fuel cell stack is permeated with the operating medium in a second direction opposite to the first direction.

During the first permeating step 101 and the second permeating step 103, the fuel cell stack is operated at a constant operating point.

FIG. 2 shows a device 200 for conditioning a fuel cell stack. The device 200 comprises a first supply system 201 for supplying fuel to an anode subsystem of a fuel cell stack 229, a second supply system 203 for supplying air to a cathode subsystem of the fuel cell stack 229, and a computing unit 205 configured to perform a conditioning method 100 according to FIG. 1.

The second supply system 203 comprises a plurality of valves 207, 209, 211 and 213, by means of which a direction of movement with which the air flows through the cathode subsystem can be reversed.

In the state shown in FIG. 2, air flows from a cathode inlet 215 to a cathode outlet 217, as indicated by arrow 219.

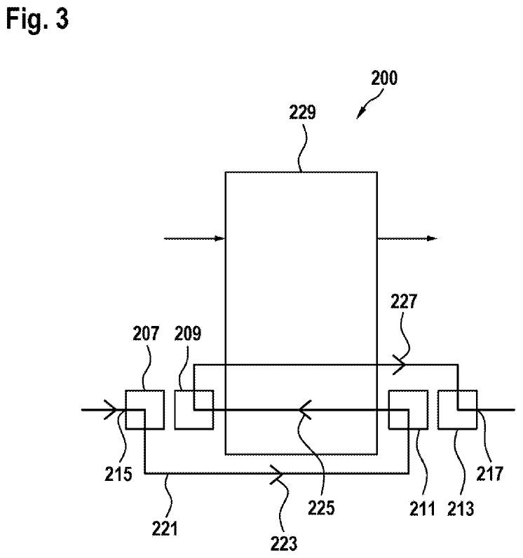

In the state shown in FIG. 3, air flows from the cathode inlet 215 via a first line 221 to the valve 213 at the cathode outlet 217, as indicated by arrow 223, which guides the air back toward the cathode inlet 215 through the fuel cell stack 229 to the valve 209, as indicated by arrow 225, which in turn guides the air past the fuel cell stack 229 to the valve 213 at the cathode outlet 217, as indicated by arrow 227.

1. A conditioning method (100) for conditioning a fuel cell stack (229),
wherein the conditioning method (100) comprises:
permeating (101) the fuel cell stack (229) with an operating medium, wherein the operating medium is guided in a first direction through the fuel cell stack (229), and
permeating (103) the fuel cell stack (229) with the operating medium in a second direction opposite to the first direction,
operating the fuel cell stack (229) at a constant operating point.

2. The conditioning method (100) according to claim 1,
wherein
the constant operating point provides a maximum electrical efficiency of the fuel cell stack (229).

3. The conditioning method (100) according to claim 1,
wherein,
for permeating the fuel cell stack (229) with the operating medium in the first direction, the operating medium is guided into a first region of the fuel cell stack (229), and for permeating the fuel cell stack (229) with the operating medium in the second direction, the operating medium is guided into a second region of the fuel cell stack (229), wherein the first region is opposite the second region.

4. The conditioning method (100) according to claim 1,
wherein
the fuel cell stack (229) is first permeated with the operating medium in the first direction and then in the second direction in a gas exchange step, and the gas exchange step is repeated.

5. The conditioning method (100) according to claim 4,
wherein
the gas exchange step is repeated until an increase in efficiency of selected fuel cells of the fuel cell stack (229) during supply with the operating medium falls below a predefined efficiency threshold value.

6. The conditioning method (100) according to claim 4,
wherein,
after the gas exchange step, a post-conditioning step is carried out in which the operating medium is guided into the fuel cell stack (229) with a second lambda value that is greater than a first lambda value with which the operating medium is guided into the fuel cell stack (229) during the gas exchange step, wherein an operating point of the fuel cell stack (229) is periodically changed during the post-conditioning step.

7. The conditioning method (100) according to claim 6,
wherein
the first lambda value is between 0.9 and 1.1 and the second lambda value is between 1.1 and 1.9.

8. The conditioning method (100) according to claim 1,
wherein
while the fuel cell stack (229) is being permeated with the operating medium, an anode subsystem of the fuel cell stack (229) is being permeated with fuel in a stoichiometric ratio.

9. The conditioning method (100) according to claim 1,
wherein
the operating medium comprises air and is guided with a first lambda value into a cathode subsystem of the fuel cell stack (229) and an anode subsystem of the fuel cell stack (229) is supplied with fuel in a stoichiometric ratio.

10. A device (200) for conditioning a fuel cell stack (229), wherein the device (200) comprises:
a first supply system (201) for supplying fuel to an anode subsystem of the fuel cell stack (229),
a second supply system (203) for supplying air to a cathode subsystem of the fuel cell stack (229),
a computing unit (205) configured to perform a conditioning method (100) according to claim 1,
wherein at least the second supply system (203) comprises a plurality of valves (207, 209, 211, 213) by which a direction of movement with which the air flows through the cathode subsystem can be reversed.

11. The device (200) according to claim 10,
wherein
the first supply system (201) comprises a plurality of valves by which a direction of movement with which fuel flows through the anode subsystem can be reversed.

12. The conditioning method (100) according to claim 7, wherein the first lambda value is 1.0 and the second lambda value is 1.2 or 1.4 or 1.6 or 1.8.

13. The conditioning method (100) according to claim 5, wherein, after the gas exchange step, a post-conditioning step is carried out in which the operating medium is guided into the fuel cell stack (229) with a second lambda value that is greater than a first lambda value with which the operating medium is guided into the fuel cell stack (229) during the gas exchange step, wherein an operating point of the fuel cell stack (229) is periodically changed during the post-conditioning step.
